(19) United States
(12) Patent Application Publication
(10) Pub. No.: US 2004/0119583 A1
(43) Pub. Date: Jun. 24, 2004

(54) Bicycle-mountable lock usable with a remotely controllable bicycle lock and alarm system

(76) Inventors: Edward A. Linden, Tucson, AZ (US); Donald J. Booty JR., Cave Creek, AZ (US)

Correspondence Address: Steven Thrasher, 391 Sandhill Dr., Richardson, TX, 75080, US

(21) Appl. No.: 10/324,375

(22) Filed: Dec. 19, 2002

(51) Int. Cl. B62J 3/00

(52) U.S. Cl. 340/432

(57) ABSTRACT

The invention provides a bicycle-mountable lock. The lock rigidly attaches to a first portion of a bicycle, and includes an attachable portion. An audible alarm sounds when either the lock is broken or when the attachable portion is broken, typically by a thief attempting to steal a bicycle. Also optionally provided in the lock and alarm is an audible alarm.

### RELATED APPLICATIONS

The invention is related to and claims priority from co-pending and co-assigned U.S. patent application Ser. No. 10/153,528 entitled Remotely Controllable Bicycle Lock and Alarm System to Linden, et al. filed on May 22, 2002.

### TECHNICAL FIELD

Generally, the invention relates to the field of locking and alarm devices, and more particularly, to bicycle locks and alarm systems.

### STATEMENT OF A PROBLEM ADDRESSED BY THIS INVENTION

Bicycles are often stolen, and if recovered, frequently have damage that is irreparable. Replacing a stolen or damaged bicycle is expensive and time consuming. To keep bicycles from being stolen, many bicycle riders turn to bicycle locks.

Bicycle locks tend to be heavy, bulky, and cumbersome to lock and unlock. Because securing a bicycle is difficult, bicycle locks and restraints require a significant amount of dexterity to lock or unlock. To a student trying to get from class to class at a university or other school, or to a delivery person who uses a bicycle, the difficulty of locking a bike makes locking and unlocking the bike impractical, while the time it takes to lock and unlock the bicycle makes getting from class to class on time difficult. The result is that some of the very people who need to lock a bicycle the most, never do.

Accordingly, to overcome these and other disadvantages associated with bicycle locking mechanisms, it would be advantageous to have a bicycle lock and alarm system that locks and unlocks quickly, and alerts a user of an ongoing theft or bicycle tampering. The invention disclosed herein provides such an invention.

Selected Overview of Selected Embodiments

The invention provides technical and operational advantages as a bicycle lock and alarm. Generally, the invention includes at least a first circuit and a second circuit, the first circuit enabled to integrate with a moving portion of the bicycle, and the second circuit capable enabled to wrap about a stationary portion of the bicycle. Additionally, the bicycle lock and alarm has a control circuit. A sound generator, a locking mechanism, and an input/out system are also coupled to the control circuit. The control circuit is enabled to lock and unlock the locking mechanism. Accordingly, the invention provides a user a device that sounds an alarm if the device or a bicycle is tampered. Optionally, a radio wave processor enabled to receive a communication from a remote control device is provided to enable remote activation and deactivation of the alarm and lock.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 shows a remotely controllable bicycle lock and alarm system with a remote control system; and

FIG. 2 provides an external view of a remotely controllable bicycle lock and alarm system, particularly showing selected interface components;

FIG. 3 shows one embodiment of a lock and alarm device;

FIG. 4 illustrates one embodiment of a circuit for a lock and alarm device; and

FIG. 5 provides one alternative embodiment showing selected electromechanical components for a lock and alarm circuit tampering system.

### AN EXEMPLARY EMBODIMENT OF A BEST MODE

The invention provides inventive embodiments that allow for theft prevention through a bicycle locking mechanism and alarm system. The invention optionally provides is a control system receiver to enable a user to at least remotely lock and unlock a bicycle lock. The lock and alarm also has a control circuit. These features make it much more difficult for a thief to steal a bike since even if the chain about a tire or pedal is broken, the alarm attached to the bike will continue to sound. Another advantage of one embodiment of the invention is the ability to send and receive an alarm message remotely, ensuring user notification of tampering or attempted theft when the user is away from the bicycle lock. Further, a user operator can alter codes needed to lock or unlock the locking mechanism, ensuring even greater security. Thus, the benefits listed are among the invention's many advantages. Others advantages are readily apparent to those of ordinary skill in the art.

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in 112, paragraph 6 of 35 U.S.C., unless used as “means for functioning—” or “step” for—functioning—“in the Claims section.

Exemplary Devices

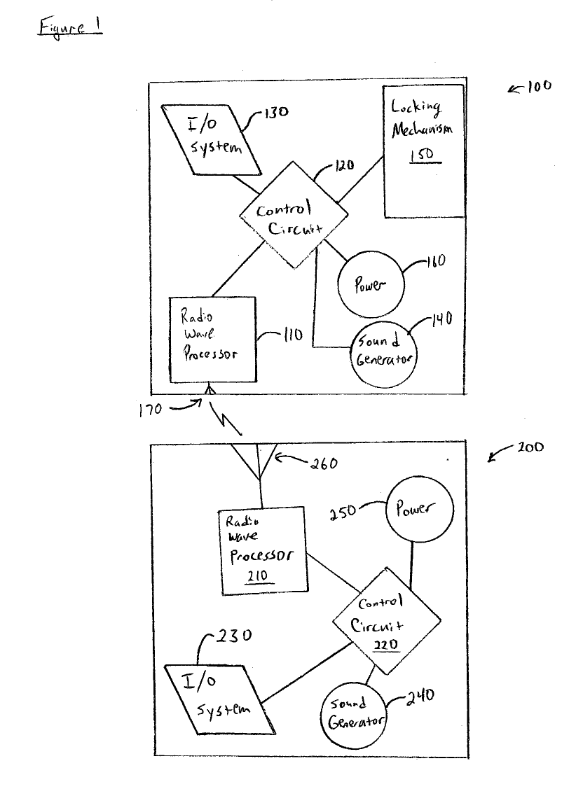

Features and advantages of the invention are better understood by reference to the drawings. Accordingly, FIG. 1 is a remotely controllable bicycle lock and alarm system (the lock and alarm system) 100 that includes a radio wave processor 110. The radio wave processor is any device capable of wireless communication, such as a transceiver, a receiver, or a transmitter. In addition, the radio wave processor may operate at any frequency band, such as 2.4 GHz, and is preferably operable at the 900 MHz bandwidth.

A control circuit 120 generally couples (or links) the electronic components of the lock and alarm system 100 so that information, preferably comprising unique bit streams, received by the radio wave processor 110 may be interpreted into various device commands, and also builds bit streams that are then sent to a remote control system 200. In addition, the control circuit 120 provides logic and electronic components to control the operation of mechanical devices, such as a locking mechanism that could be a locking actuator, for example, as well as electrical devices, such as a sound generator 140 that could be an alarm, for example.

The invention provides an input/output system 130. In some embodiments of the invention, the input/output system 130 includes a keypad having entry keys for manually entering information based on alphanumeric characters or symbols printed upon the entry keys. However, it should be understood that the input/output system 130 is not device limited, and could be comprised of any means that enables a user to enter a command or information into the lock and alarm system 100.

The sound generator 140 is capable of generating an audible alarm. For example, the alarm could be a high-pitched continuous audible sound. In other embodiments, the alarm sound could be an audible frequency of varying volume, a sound with broken intervals of silence, a sound with varying pitches, or some other audible pattern or series of patterns. In one embodiment, the sound generator 140 plays music, such as a school fight song. These different alarms could each be associated with different alarm conditions.

The locking mechanism 150 includes a securing means such as a cable or a bar (for example) that securably attaches to and immobilizes a bicycle. Thus, the locking mechanism 150 may provide security by preventing wheel movement, immobilizing the sprocket, attaching the bicycle to a stationary object, or otherwise securing the bicycle from theft. A power connector 160, enabled to receive a battery (not shown) provides power to the lock and alarm system 100, while an internal antenna 170 facilitates the reception and transmission of radio waves.

Also shown in FIG. 1 is a remote control system (the remote control system) 200, preferably having a key-ring receivable portion (not shown). A radio wave processor 210 for the remote control system 200 is similar to the radio wave processor 110 in that is can be a transceiver, a transmitter, or a receiver, and together with the radio wave processor 110 forms a wireless link that communicatively couples the remote control device 200 and the lock and lock and alarm system 100. The remote control device 200 also includes a control circuit 220, and an input/output device 230. Like the control circuit 120, the control circuit 220 generally links the electronic components of the remote control system 200 so that information, such as bit streams received by the radio wave processor 210 may be interpreted into various device commands, and provides logic and electronic components to control the operation of electrical and mechanical devices. Furthermore, the control circuit 220 builds the bit streams that provide control signals for the lock and alarm system 100.

A sound generator 240, also similar to the sound generator 140, provides the ability to sound an alarm for a user, whenever the user is away from the lock and alarm system 100, but within a transmission range from the lock and alarm system 100. The transmission range is dependent on the type of wireless system used for transmission, and may vary from a few hundred feet with a 900 MHz system, or a 2.4 GHz system, to a few miles with a wireless network, such as a PCS, CDMA, GSM, or CDPD cell phone/pager network. To supply energy to operate the remote control device's electronics, a power connector 250 is enabled to receive a battery. Likewise, an internal antenna 260 facilitates communication between the lock and alarm system 100 and the remote control system 200.

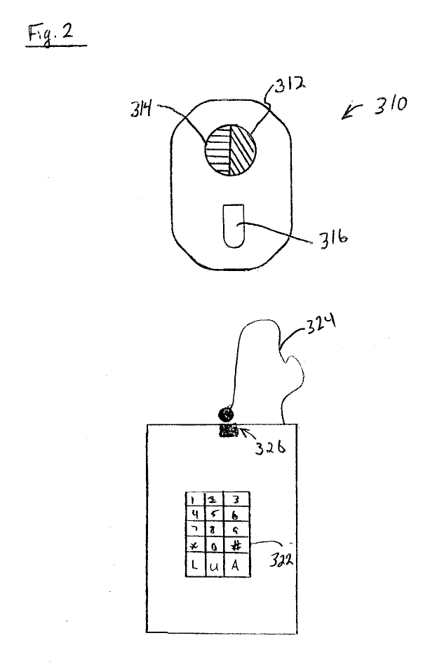

FIG. 2 shows an external diagram of a remotely controllable bicycle lock and alarm system with a remote control system, showing selected human interface components and their physical relationship to the internal systems. Consider that a remote control system 310 may include a physical key (not shown).

Also included in the remote control system 310 are a first button 312 and a second button 314 that permit the activation of selected functions. Although the buttons 312, 314 are illustrated as one half of a single hemisphere, it should be understood that the buttons 312, 314 may take different forms in other embodiments. For example, the buttons could be on either end of a generally rectangular toggle switch.

Typically, the buttons 312, 314 operate various remote control system functions. For example, the first button 312 could activate an “alarm on” (arm alarm) function, and the second button 314 could provide an “alarm off” (disarm alarm) function. In addition, the buttons 312, 314 could, when pressed, alternate the alarm from a first status to a second status, the second status being different from the fist status. Thus, if the first button 312 controls an alarm function, and the alarm is in a first state being the on state, then pressing the first button 312 turns the alarm to the off state. Similarly, if the first button 312 controls an alarm function, and the alarm is in a first state being the off state, then pressing the first button 312 turns the alarm to the on state.

The particular function activated may depend on the number of times the button is depressed within a short time frame (similar to clicking or double-clicking a mouse of a computer system). Other functions include lock and unlock, arm alarm and disarm alarm, lights on and lights off, and test alarm, for example. It will be recognized by those of ordinary skill in the art that other functions can be built in or programmed by a lock and alarm system user.

In a preferred embodiment, a third button 316 is a panic button that provides immediate activation of the audible alarm when the third button 316 is depressed. In other embodiments, the button 316 could activate another function. Of course, other buttons and keys may be provided in other embodiments and provide a number of functions.

Also depicted in FIG. 2 is a lock and alarm system 320 which includes a keypad 322 having a plurality of entry keys for manually providing information to the lock and alarm system, and the keypad may provide alphanumeric characters or symbols printed upon entry keys. The keypad 322 is used to program the lock and alarm system 320, and may be used to select a lock combination, and to enter a lock or unlock sequence if the remote control device is unavailable.

Further provided in the lock and alarm system 310 is a locking mechanism 326 that secures and releases a cable 324 or other securing means so to provide a mechanical structure that holds a bicycle component to a stationary object, or secures the bicycle in such a way as to make the bicycle immobile. In addition, a physical key slot (not shown) may receive a physical key in the event that the remote control device is unavailable. Preferably, for embodiments having a physical key, when a physical is inserted into slot and turned, a micro switch is activated that blocks the sounding of any audible alarm.

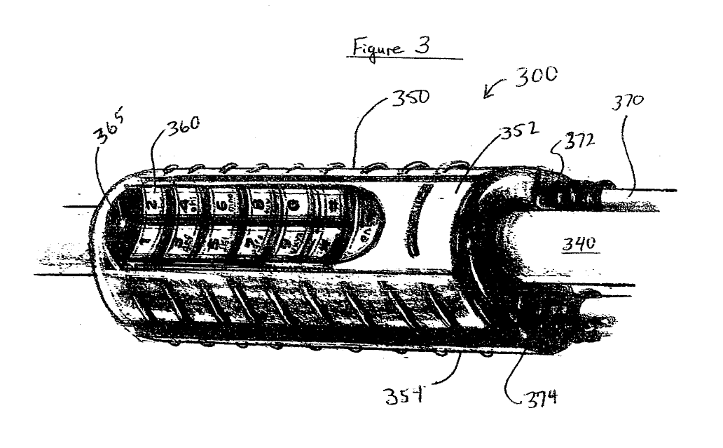

FIG. 3 shows one embodiment of a lock and alarm device 300. The lock and alarm device (the lock device) 300 includes a housing 350 which generally includes a base 352 and a door 354 that is preferably hinged to the base 352. The housing 350 is preferably substantially aerodynamically-shaped, such as the cylindrical shape of FIG. 3, and in one preferred embodiment, the housing 350 comprises a permanent locking assembly that permanently affixes the housing 350 to a stationary portion of a bicycle. The base 352 is sized to fit about a stationary portion 340 of a bicycle, such as handlebars, bike frame or other stationary bike structure that is known to those of ordinary skill in the art. The area of the stationary portion 340 to which the housing 350 is attached is defined as an attachment location. A movable member 370 couples to the housing 350 at a first position 372 and a second position 374.

The movable member 370 may be permanently attached to either or both of the first position 372 and/or the second position 374, or may be removable from the first position 372 and/or the second position 374. Of course, if the movable member 370 is permanently attached to both the first position 372 and the second position 374, some other means of securing ends (not shown) of the movable member 370 about a movable portion of the bicycle may be needed to operate the invention. Also included in the housing 350 is an input/output device 360, illustrated in FIG. 3 as alphanumeric keys, and an indicator LED 365.

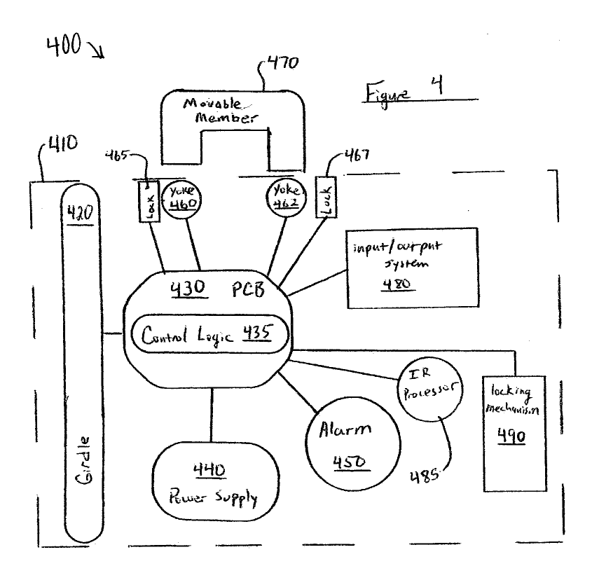

Better appreciation of the invention can be gained by a system-level analysis of the invention's components. Accordingly, FIG. 4 illustrates one embodiment of a system-level circuit 400 for a lock and alarm that is powered by a power supply 440. The circuit 400 generally resides in a housing 410, which maintains a girdle 420. The girdle is a conductive material and completely surrounds a stationary portion at an attachment location such that if the housing is separated from the attachment location, the girdle 420 is “opened” and an open-circuit condition is created in the girdle. This, in one embodiment, causes an alarm to sound as discussed below.

The girdle is coupled to a printed circuit board (PCB) 430 that maintains the electrical connections needed to properly associate the systems of the circuit 400. A control logic 435 is coupled to, and preferably resides on, the PCB 435. The control logic 435 could be a digital signal processor, a processor, or any logic circuit capable of at least detecting an open-circuit condition and is also preferably capable of sending control signals to various circuit components. In an alternative embodiment, the control logic 435 can receive signals from an infrared processor 485 and an input/output system 480, and may lock and unlock a first yoke 460 with a first lock 465, and a second yoke 462 having a second lock 467 based on input signals and commands from the input/output system 480 and the IR processor 485. Thus, the control logic 435 can unlock the movable member 470 from the yokes 460, 462 that are secured in the housing 410. The IR processor 485 is capable of communication with a remote control device (not shown) that can command the circuit 400 to unlock the movable member from the housing, and to turn off an alarm. Similarly, a locking mechanism 490 is also operable via the control logic 435 to open and lock the housing 410 about the attachment location.

The yokes 460, 462 preferably have intelligence capable of reporting the attachment status of a movable member 470. In addition, when a yoke is involuntarily opened, or when a short circuit is detected in either the movable member or the locking mechanism 490 or girdle 420, an alarm 450 (preferably an audible alarm), is activated.

The movable member 470 includes an electrical conductor that is electrically insulated from the environment. When in a locked mode, the movable member 470 is preferably attached to a movable member of a bicycle, such as a tire, a pedal, or some other movable portion of a bicycle that is known to those of ordinary skill in the art.

Thus, one preferred bicycle lock and alarm provides a housing 450 that is adapted to rigidly attach to a stationary portion of a bicycle at an attachment location. The housing 450 comprises an electrically insulating material, such as plastic or rubber, that electrically isolates a girdle 420 made of a conductive material. Although a girdle in not required for the invention, the conductive material should encompass the attachment location. A movable member 470 is adapted to attach to both the housing 410 and to a moving portion of a bicycle (not shown). The movable member 470 includes an electrically insulating material that electrically isolates a conductive material, and thus may be embodied as a wire, but should be strong enough to mechanically secure the movable member 470 to the movable portion of the bicycle. Accordingly, the conductive material electrically couples the movable member to the housing.

Thus, a first circuit is defined as comprising the conductive material of the flexible member and the circuit of the housing (logically, the first circuit adapted to detect an open-circuit condition in the flexible member). Similarly, a second circuit is defined as comprising the conductive material (girdle) of the housing, where logically speaking, the second circuit is adapted to detect an open-circuit condition in the housing. The control logic 435 is coupled to the first circuit and to the second circuit in order to turn on an alarm when either the first circuit or the second circuit detects an open circuit condition.

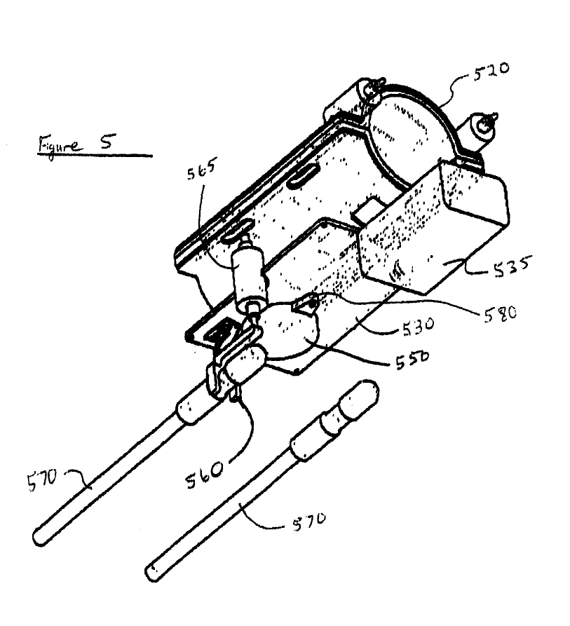

FIG. 5 provides one alternative embodiment showing selected electromechanical components for a lock and alarm circuit tampering system 500. The tampering system includes a conductive girdle 520 that is coupled to a printed circuit board 530. A control logic 535 is shown coupled to the printed circuit board 530 via a parallel port connector (not shown). Similarly, an alarm 550 is attached to the printed circuit board 530, and a movable member assembly 560, comprising a yoke and a locking solenoid actuator 565, is coupled to the printed circuit board 530. Note that although one movable member assembly 560 is shown in FIG. 5, it should be understood that at least a second locking member assembly should be provided to enable the movable member 570 to fully couple to the system 500. Furthermore, an infrared receiver 580 is coupled to the printed circuit board 530 so that remote signals can be received from an infrared remote control device.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A bicycle lock and alarm (the lock), comprising:
a housing that is adapted to rigidly attach to a stationary portion of a bicycle at an attachment location; the housing comprising an electrically insulating material that electrically isolates a conductive material; the conductive material encompassing the attachment location;
a movable member that is adapted to attach to both of the housing and to a moving portion of a bicycle; the movable member comprising an electrically insulating material that electrically isolates a conductive material; the conductive material electrically couples the movable member to the housing;
a first circuit comprising the conductive material of the flexible member; the first circuit adapted to detect an open-circuit condition in the flexible member;
a second circuit comprising the conductive material of the housing; the second circuit adapted to detect an open-circuit condition in the housing; and
a control circuit maintained in the housing; the control circuit coupled to the first circuit and to the second circuit; the control circuit adapted to turn on an alarm when a short circuit is detected by either the first circuit or the second circuit.

2. The lock of claim 1 wherein the alarm is an audible alarm.

3. The lock of claim 1 further comprising an input/output system coupled to the control circuit.

4. The lock of claim 1 further comprising an infrared processor coupled to the control circuit.

5. The lock of claim 4 further comprising a locking mechanism coupled to the control circuit and wherein the control circuit is enabled to lock and unlock a locking mechanism.

6. The lock of claim 5 wherein the locking mechanism is enabled to unlock the movable member from the housing.

7. The lock of claim 5 wherein the locking mechanism is enabled to unlock the housing from the location of attachment.

8. The lock of claim 1 wherein the stationary portion is a bike frame.

9. The lock of claim 1 wherein the stationary portion is a handlebar.

10. The lock of claim 1 wherein the movable member is a tire.

11. The lock of claim 1 wherein the movable member is a pedal.

12. The lock of claim 1 wherein the conductive material in the housing forms a cage.

13. The lock of claim 4 wherein the infrared processor is capable of communication with a remote control device, the remote control device being enabled to unlock the movable member from the housing, and to turn off an alarm.

14. The lock of claim 3 wherein the input/output system comprises a keypad having entry keys for manually entering information based on alphanumeric characters or symbols printed upon the entry keys.

15. The lock of claim 1 wherein the housing comprises a base and a hinged door.

16. The lock of claim 1 wherein the housing is substantially aerodynamically-shaped.

17. The lock of claim 1 wherein the housing comprises a permanent locking assembly.

18. A bicycle lock and alarm (the lock) tampering system, comprising:
a conductive girdle;
a printed circuit board coupled to the girdle;
a control logic coupled to the printed circuit board;
an alarm coupled to the printed circuit board; and
a movable member assembly coupled to the printed circuit board.

19. The lock of claim 18 further comprising an infrared receiver coupled to the printed circuit board.

20. The lock of claim 18 further comprising an actuator coupled to the printed circuit board.
